(19) United States
(12) Patent Application Publication
(10) Pub. No.: US 2026/0253503 A1
(43) Pub. Date: Aug. 27, 2026

(54) PRIVACY-PRESERVING AND EFFICIENT LOW-ALTITUDE ROUTE AUTHENTICATION METHOD

(71) Applicant: Harbin Inst. of Tech. (Shenzhen) (Harbin Inst. of Tech. Shenzhen Inst. of Sci. and Tech. Inno.), Shenzhen (CN)

(72) Inventors: Qinglei KONG, Shenzhen (CN); Haolan LI, Shenzhen (CN); Bo CHEN, Shenzhen (CN); Yamin ZHANG, Shenzhen (CN)

(21) Appl. No.: 19/535,866

(22) Filed: Feb. 10, 2026

Related U.S. Application Data
(63) Continuation of application No. PCT/CN2025/089775, filed on Apr. 18, 2025.

(30) Foreign Application Priority Data
Dec. 4, 2024 (CN) 2024117674787

(51) Int. Cl. G08G 5/59; H04L 9/30

(52) U.S. Cl. CPC G08G 5/59; H04L 9/3073; H04L 2209/84

(57) ABSTRACT

A privacy-preserving and efficient low-altitude route authentication method. In the route verification information generation phase, the trusted authority center defines the legal routes of UAVs for each sentry station and generates a Bloom filter. The trusted authority center uses this filter to generate elements and send them to the sentry stations to prepare for subsequent verification. In the route verification phase, the sentry stations receive the real-time flight data of UAVs, use the Bloom filter to screen out elements of illegal routes, process them, and then send them to the trusted authority center. The trusted authority center verifies the received elements, and if the verification is successful, the corresponding routes are confirmed as legal. This method ensures that only UAVs flying on legal routes can pass the verification, protects the privacy of route information, and reduces computing and communication overheads at the same time.

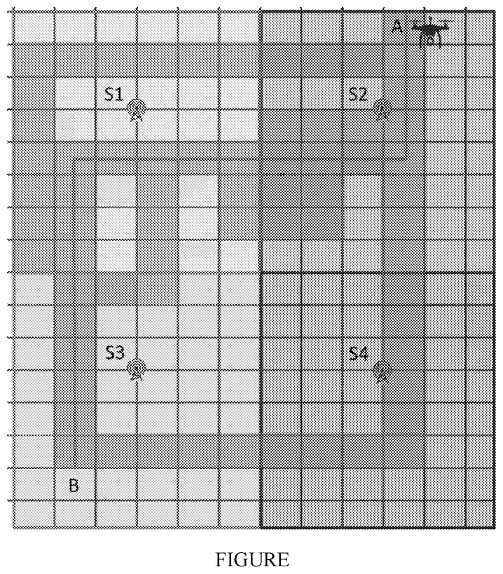

### CROSS REFERENCE TO RELATED APPLICATIONS

This application is a continuation application of PCT/CN2025/089775 filed on 2025 Apr. 18, which claims priority to CN patent application NO. CN202411767478.7 filed on 2024 Dec. 4. The contents of the above-mentioned applications are all hereby incorporated by reference.

### TECHNICAL FIELD

The present invention relates to the technologies of UAV route verification and wireless communication network security, particularly to a privacy-preserving and efficient low-altitude route authentication method.

### BACKGROUND

With the booming development of the low-altitude economy, the UAV logistics business has started to emerge and expand. Operators open a large number of routes and build take-off and landing points in cities to complete a considerable number of cargo delivery tasks. In this operation system, the flight control center plans the routes for each UAV logistics mission. The UAV needs to select a specific flight route from multiple assigned legal routes to carry out point-to-point cargo transportation in urban airspace.

However, as the scale of the low-altitude UAV traffic network continues to expand, the traditional centralized supervision method is difficult to meet the requirements. To achieve effective supervision, the air traffic control center may delegate part of the airspace management authority to the offline sentry stations distributed in cities in the future. These sentry stations are deployed and managed by third-party institutions. But this supervision model faces severe security challenges. On the one hand, registered UAVs may be hijacked and fly randomly, and unregistered UAVs may occupy the routes and fly illegally. These behaviors pose a threat to public safety, requiring sentry stations to be able to judge the legality of the flight routes of UAVs in their airspace in real-time. On the other hand, since UAVs often carry out commercial flight missions, their route information has important commercial value. As UAVs and sentry stations belong to different institutions, third-party sentry stations may steal the complete route information. Therefore, UAVs need to avoid disclosing additional route information to sentry stations during the authentication process.

When dealing with these security challenges, the hardware limitations of UAVs themselves also need to be considered. As edge devices, UAVs have limited computing resources and are difficult to support the high-energy-consumption requirements brought by complex cryptographic systems. At the same time, the UAV logistics scenario has a high requirement for communication real-time performance and cannot afford too many rounds of communication interaction. Therefore, how to complete the legality verification of UAV routes and protect the privacy of route data under limited resource conditions has become an urgent problem to be solved.

Existing UAV security protection technologies mainly focus on the confidentiality and integrity of communication links, establishing trust relationships through various identity authentication and key-establishment protocols. However, there is relatively insufficient research on achieving efficient verification while protecting route privacy. Especially considering the resource constraints of UAVs, it is also an important problem to be solved to complete efficient route verification on the premise of ensuring data security.

### UAV Network Security Technologies Based on Cryptographic Protocols

With the rapid development of UAV logistics and the continuous expansion of application scenarios, the security verification of UAV routes faces unprecedented challenges. The large-scale use of UAVs increases the risks of illegal intrusion and hijacking. Once a hacker organization masters the intrusion method for a certain type of UAV, it may lead to large-scale security accidents, which not only endanger public safety but also may seriously disrupt urban airspace management. Currently, the security research on UAV route verification mainly focuses on three aspects: UAV communication security protocols, route authentication mechanisms, and identity management systems.

UAV Communication Security Protocols: Mainly rely on designing key distribution and management frameworks to ensure the communication security between UAVs and ground control centers, and guarantee the confidentiality, integrity, and authenticity during the instruction transmission and data feedback processes.

Route Authentication Mechanisms: Use cryptographic methods to authenticate and verify the integrity of route information, ensuring that UAVs fly along the specified legal routes and preventing routes from being tampered with or forged.

Identity Management Systems: Include UAV registration authentication and real-time identity verification, involving the establishment of multi-party mutual trust mechanisms, key updates, and the validity period management of identity credentials.

Currently, UAV route verification has become the focus of attention in the industry because it provides necessary security guarantees for urban low-altitude traffic management. By setting up distributed sentry stations, UAVs can be monitored in real-time and their routes can be verified. However, existing verification technologies based on cryptographic protocols mainly focus on the security protection of the communication process and lack effective solutions for route privacy protection. Existing technologies mainly protect the authenticity and confidentiality of communication links but lack a mechanism for efficient verification under the premise of protecting route privacy. In addition, existing privacy-protection protocols are generally complex, require multiple rounds of interaction, and have high computing and communication overheads, which are not suitable for the actual scenarios where UAVs have limited resources.

It should be noted that the information disclosed in the above background art section is only for understanding the background of this application and may include information that does not constitute prior art known to those of ordinary skill in the art.

### SUMMARY

The primary aim of the present invention is to surmount the shortcomings presented in the background art described above and provide a privacy-preserving and efficient low-altitude route authentication method.

To attain the aforesaid objective, the present invention employs the following technical means:

A privacy-preserving and efficient low-altitude route authentication method includes a system initialization phase, a route verification information generation phase, and a route verification phase.

The system initialization phase includes: The trusted authority center sets the fundamental security parameters of the system, encompassing a hash function and bilinear mapping parameters, and initializes the Bloom filter. The trusted authority center and sentry stations are configured to get ready for subsequent data processing.

The route verification information generation phase includes: The trusted authority center demarcates the legal routes for unmanned aerial vehicles (UAVs) within the airspace of each sentry station and generates a Bloom filter. It utilizes the Bloom filter to generate corresponding elements and transmits them to the sentry stations.

The route verification phase includes: The sentry station receives the real-time flight data set of a UAV, uses the Bloom filter to filter out elements that do not pertain to the legal routes, processes the filtered elements, and sends them to the trusted authority center. The trusted authority center conducts corresponding verification on the received elements in accordance with the Bloom filter. If the verification is successful, the corresponding elements are incorporated into the final legal route set.

Furthermore, the trusted authority center is the flight control center.

Furthermore, the system initialization phase specifically comprises the following steps:

The trusted authority center provides security parameters, invokes a parameter generation algorithm to generate the hash function and bilinear mapping parameters requisite for the system, and randomly selects a number to compute the system master key.

The trusted authority center evenly divides the urban airspace into multiple unit blocks, assigns a unique identifier to each unit block, and then evenly distributes these unit blocks to respective sentry stations for management.

The trusted authority center selects a sufficiently large array to create a Bloom filter and initializes it to zero to prepare for subsequent route verification.

During the construction and registration of the sentry stations, the trusted authority center generates an airspace scope and a private key for each sentry station and delivers them offline, enabling the sentry stations to carry out subsequent route verification tasks.

Furthermore, the route verification information generation phase specifically includes the following steps:

The trusted authority center demarcates the legal routes for UAVs within the airspace of each sentry station and generates a set representing these legal routes.

The trusted authority center randomly selects a number, calculates, and generates a set representing the no-fly zone, which depicts the no-fly area for UAVs within the airspace of the sentry station.

Based on the legal route set and the no-fly zone set, the trusted authority center performs a Bloom filter construction operation to generate a hash function and a bit array.

The trusted authority center examines the unit blocks in the legal route set, identifies the false-positive blocks that might be misjudged by the Bloom filter as being in the no-fly zone, and records these false-positive blocks in a set.

The trusted authority center generates a polynomial based on the false-positive block set and randomly selects an element to generate an element sequence.

The trusted authority center uses the master key to generate a signature for the route information to guarantee the non-tamperability of the route information.

The trusted authority center distributes the generated route information and signature to UAVs for use in the subsequent route verification phase.

Furthermore, the route information encompasses the legal route set, the false-positive block set, the Bloom filter, and the element sequence.

Furthermore, the route verification phase specifically includes the following steps:

When a UAV first enters the airspace of a sentry station, the UAV transmits information including a Bloom filter, an element sequence, verification parameters, and a signature to the sentry station. The sentry station first verifies the legitimacy of the signature to confirm that the task verification information provided by the UAV is legal.

When the sentry station detects that the UAV enters a new unit block, the sentry station calculates a specific value and utilizes the Bloom filter to verify whether the unit block belongs to the legal route of the UAV. If the verification passes, the sentry station will continue to monitor the flight trajectory of the UAV.

If the unit block does not belong to the legal route, the sentry station will calculate and send a specific message to the UAV to request further verification.

Upon receiving the message from the sentry station, the UAV selects a specific element from the element sequence, calculates a verification value, and then transmits the verification value back to the sentry station.

After receiving the verification value transmitted by the UAV, the sentry station conducts a final verification. If the verification is successful, it indicates that the unit block has passed the false-positive verification and is part of the legal route of the UAV. The sentry station will continue to monitor the flight trajectory of the UAV until the UAV enters the next unit block.

A non-transitory computer-readable storage medium stores a computer program. When executed by a processor, this computer program implements the privacy-preserving and efficient low-altitude route authentication method as described above.

A non-transitory computer program product contains a computer program. When executed by a processor, this computer program implements the privacy-preserving and efficient low-altitude route authentication method as described above.

The present invention has the following beneficial effects:

In response to the challenges mentioned above, based on the low-altitude UAV logistics scenario, the present invention proposes a privacy-preserving and efficient low-altitude route authentication method. The present invention can achieve efficient legality verification on the premise of protecting the confidentiality of the complete route information of UAVs. It can be combined with existing cryptographic technologies and lightweight security computing methods to make it applicable to the situation of resource-constrained UAVs, and realize efficient and secure verification of route information. The present invention balances the protection of route privacy and the assurance of verification efficiency, has a high verification efficiency, and effectively solves the problems of limited computing power and communication resources of UAVs.

The present invention well meets the requirements of low-altitude UAV route authentication in the low-altitude UAV logistics scenario. Compared with the prior art, the advantages of the present invention mainly include: First, it ensures that only UAVs flying on legal routes can pass the verification of sentry stations. Second, it guarantees the confidentiality of the complete route information of UAVs during the verification process. Third, it realizes efficient low-altitude UAV route verification, greatly reducing the computing and communication overhead.

Other beneficial effects in the embodiments of the present invention will be further described below.

### BRIEF DESCRIPTION OF THE DRAWINGS

The sole FIGURE is a schematic diagram of the privacy-preserving and efficient low-altitude UAV route authentication scheme of the embodiment of the present invention.

### DETAILED DESCRIPTION

The following provides a detailed description of the embodiments of the present invention. It should be emphasized that the following description is merely exemplary and is not intended to limit the scope of the present invention and its applications.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element. In addition, the connection can be used for fixing, coupling, or communicating purposes.

It should be understood that terms such as “length”, “width”, “upper”, “lower”, “front”, “rear”, “left”, “right”, “vertical”, “horizontal”, “top”, “bottom”, “inner”, “outer”, etc. indicate the orientation or positional relationship based on the orientation or positional relationship shown in the drawings, which is only for the convenience of describing the embodiments of the present invention and simplifying the description, rather than indicating or implying that the device or element referred to must have a specific orientation, be constructed, and operate in a specific orientation. Therefore, it should not be construed as a limitation to the present invention.

In addition, the terms “first” and “second” are only used for descriptive purposes and cannot be construed as indicating or implying relative importance or implicitly indicating the number of technical features indicated. Thus, features defined with “first” and “second” can explicitly or implicitly include one or more of such features. In the description of the embodiments of the present invention, the meaning of “multiple” is two or more, unless otherwise specifically defined.

### Definitions of Abbreviations and Key Terms

### Bloom Filters

Bloom filters provide a probabilistic and efficient membership query function. In this scheme, Bloom filters are used for rapid testing of set members. Given a bit array B with a length of m and k mutually independent hash functions h₁, h₂, . . . , hₖ: S→[0, m−1], where S represents all possible sets. This structure has the characteristic of false positives, that is, an element not in the set may be misjudged as being in the set, but false negatives will not occur, that is, an element in the set will not be judged as not being in the set. Bloom filters mainly consist of two functions:
Bloom. Build(S)→B: Given a set S, for each element x∈S, calculate k hash values hᵢ(x) (1≤i≤k) and set the bits at the corresponding positions in the array B to 1. Output the constructed bit array B.
Bloom. Test (x, B)→True/False: Given an element x, calculate k hash values hᵢ(x) (1≤i≤k). If the k corresponding positions in B are all 1, output True (at this time, x may be in the set); otherwise, output False (at this time, x must not be in the set).

For a given array length m and set size n, there is an optimal relationship between the false-positive probability p and the number of hash functions

$$\\ k = \frac{- ( \frac{m}{n} ) ln ( p )}{ln ( 2 )} .$$

### Bilinear Maps

Given a security parameter k, [symbol] , [symbol] and [symbol] are cyclic groups satisfying |q|=k, and they meet the following properties:
Bilinearity: ∀P,Q∈G, and ∀a,

$$\\ b ∈ {ℤ}_{q}^{*} ,$$

it holds that e(aP,bQ)=e(P,Q)^{ab}.
Non-degeneracy: There exist P,Q∈G such that e(P,Q)≠1_{G}_{_{T}}.
Computability: ∀P,Q∈G, there exists an efficient algorithm to compute e(P,Q).

The bilinear parameter generator gen(⋅) represents a probabilistic algorithm that takes the parameter K as input and outputs a 7-tuple (q, [symbol] , [symbol] , [symbol] , e, P, Q). Here, q denotes a large prime number satisfying |q|=k, [symbol] and [symbol] are additive cyclic groups, [symbol] is a multiplicative cyclic group, P∈ [symbol] and Q∈ [symbol] are generators, and e: [symbol] × [symbol] → [symbol] is a bilinear map satisfying non-degeneracy and computability.

### Identity-Based Signature (IBS)

Identity-based signature provides a public-key signature mechanism without the need for certificates. In this scheme, a user's public key can be directly derived from their identity information (such as recognizable strings like email addresses and phone numbers), eliminating the need for additional public-key certificates. The entire system is maintained by a trusted Private Key Generator (PKG). The PKG holds the Master Secret Key (MSK) of the system and is responsible for generating corresponding private keys for users. IBS mainly consists of the following four algorithms:
Setup(λ)→(MPK, MSK): Input the security parameter λ to generate the system's master public key MPK and master private key MSK. The MPK is publicly available, and the MSK is securely stored by the PKG.
Extract(MSK, ID)→SK: The PKG uses the MSK to generate the corresponding private key SK for the user identity ID. This process requires identity authentication to ensure that the private key is only issued to legitimate users.
Sign(M, SK)→σ: The user uses the private key SK to sign the message M and generates the signature value \sigma.
Verify(M, ID, σ)→True/False: Anyone can use the signer's identity ID to verify the validity of the signature σ on the message M. If the signature is valid, it outputs True; otherwise, it outputs False.

The security of this scheme is based on the unforgeability of signatures. That is, without the corresponding private key, an attacker cannot generate a valid signature for an arbitrary message, even if the attacker can obtain the private keys of other identities and the signatures of arbitrary messages.

In the low-altitude UAV logistics scenario, to prevent unauthorized and random flights of UAVs, third-party offline sentry stations must verify the legality of UAV flight routes in real-time. Moreover, since UAV route information has potential commercial value, the privacy of UAV route information needs to be ensured during the verification process, preventing third-party sentry stations from obtaining additional UAV route information. At the same time, as edge devices, UAVs have limited computing resources and can hardly meet the energy-consumption requirements of complex cryptographic systems. The scenario has high requirements for communication real-time performance, and the number of communication interactions should not be excessive. It is necessary to complete route verification and protect data privacy under limited resource conditions.

As shown in the sole FIGURE, for the low-altitude UAV logistics scenario, the embodiment of the present invention proposes a privacy-preserving and efficient low-altitude UAV route authentication method. This method is applicable to the situation where UAVs have limited resources. It can achieve efficient and secure verification of route information on the premise of protecting the confidentiality of the complete route information of UAVs. In the sole FIGURE, A and B represent the starting and ending points of the UAV route, and S1 to S4 represent different sentry stations.

This privacy-preserving and efficient low-altitude route authentication method includes a system initialization phase, a route verification information generation phase, and a route verification phase.

The system initialization phase includes: The trusted authority center (such as the flight control center) sets the basic security parameters of the system, including hash function and bilinear mapping parameters, and initializes the Bloom filter. The trusted authority center and sentry stations are configured to prepare for subsequent data processing.

The route verification information generation phase includes: The trusted authority center demarcates the legal routes of UAVs under the airspace of each sentry station and generates a Bloom filter. It uses the Bloom filter to generate corresponding elements and sends them to the sentry stations.

The route verification phase includes: The sentry station receives the real-time flight data set of a UAV, uses the Bloom filter to filter out the elements that do not belong to the legal routes, processes the filtered elements and sends them to the trusted authority center. The trusted authority center conducts corresponding verification on the received elements according to the Bloom filter. If the verification is successful, the corresponding elements are placed into the final legal route set.

In a preferred embodiment, the system initialization phase specifically includes the following steps:
(1) Set basic system security parameters: The trusted authority center (TA) provides security parameters, invokes a parameter generation algorithm to generate the hash function and bilinear mapping parameters required by the system, and randomly selects a number to calculate the system master key.
(2) Divide urban airspace: The trusted authority center evenly divides the urban airspace into multiple unit blocks, assigns a unique identifier to each unit block, and then evenly distributes the unit blocks to each sentry station for management.
(3) Initialize the Bloom filter: The trusted authority center selects a sufficiently large array to create a Bloom filter and initializes it to 0 to prepare for subsequent route verification.
(4) Generate sentry station airspace range and private key: When the sentry stations are built and registered, the trusted authority center generates the airspace range and private keys for them and delivers them offline to the sentry stations so that the sentry stations can carry out subsequent route verification work.

In a preferred embodiment, the route verification information generation phase specifically includes the following steps:
(1) Demarcate legal routes: The trusted authority center (TA) demarcates the legal routes of UAVs under the airspace of each sentry station and generates a set representing the legal routes.
(2) Generate the no-fly zone set: The TA randomly selects a number, calculates and generates a set representing the no-fly zone. This set describes the no-fly zone of UAVs under the airspace of the sentry station.
(3) Construct the Bloom filter: Based on the legal route set and the no-fly zone set, the TA performs a Bloom filter construction operation to generate a hash function and a bit array.
(4) Identify false-positive blocks: The TA checks the unit blocks in the legal route set, identifies the false-positive blocks that may be misjudged by the Bloom filter as being in the no-fly zone, and records these false-positive blocks in a set.
(5) Generate a polynomial and an element sequence: The TA generates a polynomial based on the false-positive block set and randomly selects an element to generate an element sequence.
(6) Generate a signature: The TA uses the master key to generate a signature for the route information to ensure the non-tamperability of the route information. The route information includes the legal route set, the false-positive block set, the Bloom filter, and the element sequence, etc.
(7) Distribute route information: The TA distributes the generated route information and signature to UAVs for use in the subsequent route verification phase.

In a preferred embodiment, the route verification phase specifically includes the following steps:
(1) Preliminary verification: When a UAV first enters the airspace of a sentry station, the UAV sends information including a Bloom filter, an element sequence, specific parameters, and a signature to the sentry station. The sentry station first verifies the legality of the signature to confirm that the task verification information provided by the UAV is legal.
(2) Real-time route verification: When the sentry station detects that the UAV enters a new unit block, the sentry station calculates a specific value and uses the Bloom filter to verify whether the unit block belongs to the legal route of the UAV. If the verification is passed, the sentry station will continue to monitor the flight trajectory of the UAV.
(3) Handle false-positive situations: If the unit block does not belong to the legal route, the sentry station will calculate and send a specific message to the UAV to request further verification.
(4) UAV response: After receiving the message from the sentry station, the UAV selects a specific element from the element sequence, calculates a verification value, and then sends the verification value back to the sentry station.
(5) Final verification: After receiving the verification value sent by the UAV, the sentry station conducts a final verification. If the verification is successful, it indicates that the unit block has passed the false-positive verification and belongs to a part of the legal route of the UAV. The sentry station will continue to monitor the flight trajectory of the UAV until the UAV enters the next unit block.

Through the above steps, the route verification phase ensures the legality of the UAV's flight route within the airspace of the sentry station and handles possible false-positive situations, thus guaranteeing the flight safety of the UAV and the privacy of its data.

The above-mentioned embodiments of the present invention have designed a UAV low-altitude route authentication method based on multi-party secure computing technology, achieving privacy protection for UAV low-altitude routes and completing efficient route verification on the premise of ensuring data security. In this method, third-party sentry stations can only obtain the actual flight routes of UAVs and cannot access the complete legal route information. In the embodiments of the present invention, a low-altitude route verification scheme using a BLOOM filter and a concise private set intersection protocol is designed. The BLOOM filter is used for rapid verification, and the concise private set intersection protocol is used for re-verification of false positives, greatly reducing computing and communication overhead. At the same time, identity-based signature technology is used to ensure the non-tamperability of route information, realizing efficient UAV low-altitude route verification.

The following further describes specific embodiments of the present invention and their algorithm examples.

To meet the requirements of UAV low-altitude route authentication in the UAV low-altitude logistics scenario, the embodiments of the present invention propose a privacy-preserving and efficient low-altitude route authentication method.

The implementation process of the privacy-preserving and efficient low-altitude route authentication method of the present invention is divided into three parts: 1) system initialization; 2) route verification information generation; 3) route verification. Its workflow is as follows:

### 1) System Initialization

In the system initialization stage, assume that the Flight Control Center (FCC) serves as the Trusted Authority (TA). The TA will execute the following steps to generate the entire system.
(1) Given the security parameter k, the TA invokes gen (k) to generate the parameters (q, [symbol] , [symbol] , [symbol] , e, P,Q), where P∈ [symbol] , Q∈ [symbol] . Meanwhile, the TA randomly selects a number

$$\\ s ∈ {Z}_{q}^{*}$$

and calculates the value sk_{fcc}=s·H(id_{fcc}) as the system master key.
(2) The TA evenly divides the urban airspace into n_{c} unit blocks, assigns a random value cᵢ∈Zₙ_{_{c}} to each unit block as its unique identifier. The TA evenly distributes these unit blocks to nₛ sentry stations for monitoring, and each sentry station manages

$$\\ k = \frac{{n}_{c}}{{n}_{s}}$$

unit blocks.
(3) The TA initializes the BLOOM filter. At the same time, it selects a sufficiently large array to create the BLOOM filter and initializes it to 0.

When the sentry station j(j∈{1, 2, . . . , nₛ}) is built and registered, the TA generates its airspace range Cⱼ=(c₁, c₂, . . . , cₖ) and its private key skⱼ=s·H(idⱼ), and delivers (Cⱼ, skⱼ) offline to the sentry station j.

### 2) Route Verification Information Generation

First, the TA demarcates the legal routes for UAVs under the airspace of each sentry station during this mission. That is, for sentry station j, a set Xⱼ=(x₁, x₂, . . . , xₘ) is generated. If there is a unit block with the number cᵢ∈Cⱼ that is allowed to be flown through during this mission, then there exists an xᵢ in the set Xⱼ such that xᵢ=cᵢ.

The TA randomly selects a number

$$\\ r ∈ {Z}_{q}^{*} ,$$

calculates pⱼ=r·H(id_{fcc}), and generates a set Zⱼ=(z₁, z₂, . . . , zₖ₋ₘ). For all cⱼ∈C_{C}_{ⱼ}Xⱼ, there exists a zᵢ in the set Zⱼ such that zᵢ=H(cᵢ∥e(r·H(idⱼ), sk_{fcc}). The set Z describes the no-fly zone for UAVs under the airspace of sentry station j during this mission.

Based on Xⱼ and Zⱼ the TA performs the following operations to generate the mission verification information for UAVs under the airspace of sentry station j:
(1) Execute BLOOM.Build(Zⱼ) to generate k mutually independent hash functions h₁, h₂, . . . , hₖ_{^{k}} and a bit array Bⱼ with a length of l_{B}.
(2) Initialize an empty set Yⱼ=Ø. For all cᵢ∈Xⱼ, the TA checks whether there exists a cᵢ satisfying BLOOM. Test (H(cᵢ∥e(r·H(idⱼ), sk_{fcc}))=True. If so, it indicates that the unit block cᵢ is a false-positive block in the legal route. The TA adds H(cᵢ∥e(r·H(idⱼ), sk_{fcc})) to the set Yⱼ. The set Yⱼ records all the unit blocks that belong to the legal route but show false-positive results during this mission.
(3) For the given Yⱼ, the TA generates a polynomial:

$$\\ P ( {Y}_{j} , α ) = ( α + {y}_{1} ) ( α + {y}_{2} ) … ( α + {y}_{{l}_{Y}} ) mod q = {\sum }_{i = o}^{{l}_{Y}} c ( {Y}_{j} , i ) \cdot {α}^{i} mod q .$$

Here, i∈{0, 1, . . . , l_{Y}}, and c(Yⱼ, i) is the coefficient of the corresponding term of the polynomial. Based on this polynomial, the TA randomly selects g₂∈G₂ and generates the element

$$\\ {R}_{j} : {R}_{j} = {g}_{1}^{P ( {Y}_{j} , α )} .$$

Then, the TA generates the sequence R=(R₋₁, R₋₂, . . . , R₋ₗ_{ₐ}), where

$$\\ {R}_{- j} = {g}_{2}^{{\sum }_{i = o}^{{l}_{Y} - 1} c ( {Y}_{j}^{- j} , i ) \cdot {α}^{i} mod q} , ∀ j ∈ \{ 1 , 2 , … , {l}_{Y} \} .$$

The TA uses the master key to generate a σⱼ for Bⱼ∥Rⱼ:σⱼ=IBS.Sign (Bⱼ∥Rⱼ,sk_{fcc}), and distributes the route information Iⱼ=Xⱼ∥Yⱼ∥Bⱼ∥Rⱼ∥R∥pⱼ∥σⱼ under the airspace of sentry station j to the UAV.

### 3) Route Verification

When a UAV first enters the airspace of sentry station j, it sends msgⱼ₁=Bⱼ∥Rⱼ∥pⱼ∥σⱼ to the sentry station. The sentry station first verifies the legality of the signature σⱼ:

$$\\ IBS . Verify ( {B}_{j} ‖ {R}_{j} , {id}_{fcc} , {σ}_{j} ) {=}^{?} True .$$

If this equation holds, it indicates that the task verification information initially provided by the UAV is legal, and subsequent route authentication work can continue.

When sentry station j detects that the UAV enters a new unit block cᵢ, the sentry station calculates zᵢ=H(cᵢ∥e(pⱼ,skⱼ)) and verifies

$$\\ BLOOM . Test ( {z}_{i} , {B}_{j} ) {=}^{?} FALSE .$$

If this equation holds, it indicates that the unit block cᵢ is part of the UAV's legal route, and the sentry station will continue to silently monitor the UAV's flight trajectory until the UAV enters the next unit block.

If the above-mentioned equation does not hold, sentry station j calculates g₁=sⱼ·P and selects a random number

$$\\ {r}_{j} ∈ {Z}_{q}^{*} ,$$

then calculates Vⱼ:

$$\\ {V}_{j} = {( {g}_{1}^{α} \cdot {g}_{1}^{- {z}_{i}} )}^{{r}_{j}} .$$

Sentry station j sends msgⱼ₂=Vⱼ∥zᵢ to the UAV.

After receiving msgⱼ₂ sent by the sentry station, the UAV selects R_{-z}_{ᵢ} from R, calculates Wⱼ: Wⱼ=e(Vⱼ,R_{-z}_{ᵢ}), and sends msgⱼ₃=Wⱼ to sentry station j.

After receiving msgⱼ₃, sentry station j verifies:

$$\\ W {}_{j}^{\frac{1}{{r}_{j}}} = e ( {( {g}_{1}^{α} \cdot {g}_{1}^{- {z}_{i}} )}^{{r}_{j}} , {R}_{- {z}_{i}} ) {}^{\frac{1}{{r}_{j}}} {=}^{?} {R}_{j}$$

If the above-mentioned verification holds, it indicates that the unit block cᵢ has passed the false-positive verification, and cᵢ is part of the UAV's legal route. Sentry station j will continue to silently monitor the UAV's flight trajectory until the UAV reaches the next unit block.

The method of the present invention can effectively achieve privacy-protected and efficient low-altitude route authentication for the UAV low-altitude logistics scenario. In this method: 1. It uses a BLOOM filter and a concise private set intersection protocol to achieve efficient low-altitude route authentication. The scheme first uses the BLOOM filter to quickly verify whether a flying UAV is on a legal route, and then uses the private set intersection protocol to quickly verify possible misjudgment results, greatly reducing the computing and communication overhead during the verification process. 2. It combines the identity-based signature technology (IBS) to sign the UAV's granted route verification information, effectively ensuring the non-tamperability of the UAV's route verification information.

In conclusion, the present invention proposes a privacy-preserving and efficient low-altitude route authentication method, which is particularly suitable for the low-altitude UAV logistics scenario. This method realizes efficient legality verification on the premise of protecting the confidentiality of the complete route information of UAVs through three stages: system initialization, route verification information generation, and route verification. By using the Bloom filter and the private set intersection protocol, the present invention greatly reduces the computing and communication overhead during the verification process. At the same time, the identity-based signature technology is used to ensure the non-tamperability of the route verification information. This not only ensures that only UAVs flying on legal routes can pass the verification of sentry stations, but also protects the privacy of UAV route information during the verification process, avoiding the leakage of additional route information to sentry stations. In addition, this method fully considers the resource limitations of UAVs, is applicable to the situation of resource-constrained UAVs, effectively solves the problems of limited computing power and communication resources, improves the verification efficiency, and provides a secure, efficient, and privacy-protecting solution for route authentication in the low-altitude UAV logistics scenario.

The embodiments of the present invention also provide a storage medium for storing a computer program. When the computer program is executed, it at least executes the method described above.

The embodiments of the present invention also provide a control device, including a processor and a storage medium for storing a computer program. The processor is used to execute the computer program to at least execute the method described above.

The embodiments of the present invention also provide a processor. When the processor executes a computer program, it at least executes the method described above.

The storage medium can be implemented by any type of non-volatile storage device or a combination thereof. The non-volatile memory can be a read-only memory (ROM), a programmable read-only memory (PROM), an erasable programmable read-only memory (EPROM), an electrically erasable programmable read-only memory (EEPROM), a ferromagnetic random access memory (FRAM), a flash memory, a magnetic surface memory, an optical disc, or a compact disc read-only memory (CD-ROM). The magnetic surface memory can be a disk memory or a tape memory. The storage medium described in the embodiments of the present invention is intended to include, but not be limited to, these and any other suitable types of memories.

In the several embodiments provided by the present invention, it should be understood that the disclosed systems and methods can be implemented in other ways. The device embodiments described above are merely illustrative. For example, the division of units is only a logical functional division, and in actual implementation, there can be other division methods. For example, multiple units or components can be combined or integrated into another system, or some features can be ignored or not implemented. In addition, the coupling, direct coupling, or communication connection between the components shown or discussed can be through some interfaces, and the indirect coupling or communication connection of devices or units can be in electrical, mechanical, or other forms.

The units described as separate components may or may not be physically separated. The components shown as units may or may not be physical units, that is, they can be located in one place or distributed over multiple network units. Some or all of these units can be selected according to actual needs to achieve the purpose of the embodiment's solution.

In addition, in the embodiments of the present invention, the functional units can all be integrated into one processing unit, or each unit can be used as a separate unit, or two or more units can be integrated into one unit. The integrated units can be implemented in the form of hardware or in the form of a hardware-plus-software functional unit.

Those of ordinary skill in the art can understand that all or part of the steps for implementing the above-mentioned method embodiments can be completed by hardware related to program instructions. The aforementioned program can be stored in a computer-readable storage medium. When the program is executed, it executes the steps of the above-mentioned method embodiments. The aforementioned storage medium includes various media that can store program codes, such as mobile storage devices, read-only memories (ROM), random access memories (RAM), magnetic disks, or optical discs.

Alternatively, if the integrated units of the present invention are implemented in the form of software functional modules and sold or used as independent products, they can also be stored in a computer-readable storage medium. Based on this understanding, the technical solutions of the embodiments of the present invention, in essence, or the part that contributes to the prior art, can be embodied in the form of a software product. This computer software product is stored in a storage medium and includes several instructions for enabling a computer device (which can be a personal computer, a server, or a network device, etc.) to execute all or part of the methods described in the embodiments of the present invention. The aforementioned storage medium includes various media that can store program codes, such as mobile storage devices, ROM, RAM, magnetic disks, or optical discs.

The methods disclosed in the several method embodiments provided by the present invention can be combined arbitrarily without conflict to obtain new method embodiments.

The features disclosed in the several product embodiments provided by the present invention can be combined arbitrarily without conflict to obtain new product embodiments.

The features disclosed in the several method or device embodiments provided by the present invention can be combined arbitrarily without conflict to obtain new method embodiments or device embodiments.

The above content is a further detailed description of the present invention in combination with specific preferred embodiments. It cannot be determined that the specific implementation of the present invention is limited to these descriptions. For those skilled in the technical field to which the present invention belongs, without departing from the concept of the present invention, several equivalent substitutions or obvious modifications can be made, and if their performance or uses are the same, they should all be regarded as falling within the protection scope of the present invention.

1. A privacy-preserving and efficient low-altitude route authentication method, comprising a system initialization phase, a route verification information generation phase, and a route verification phase;
the system initialization phase includes: a trusted authority center setting basic security parameters of the system, including a hash function and bilinear mapping parameters, and initializing a Bloom filter; the trusted authority center and sentry stations being configured to prepare for subsequent data processing;
the route verification information generation phase includes: the trusted authority center delineating legal routes for unmanned aerial vehicles (UAVs) under the airspace of each sentry station and generating a Bloom filter; using the Bloom filter to generate corresponding elements and transmitting them to the sentry stations;
the route verification phase includes: the sentry station receiving a real-time flight data set of a UAV, using the Bloom filter to filter out elements that do not belong to the legal routes, processing the filtered elements and transmitting them to the trusted authority center, the trusted authority center performing corresponding verification on the received elements according to the Bloom filter, and if the verification is successful, placing the corresponding elements into a final legal route set.

2. The privacy-preserving and efficient low-altitude route authentication method of claim 1, wherein the trusted authority center is a flight control center.

3. The privacy-preserving and efficient low-altitude route authentication method of claim 1, wherein the system initialization phase specifically comprises the following steps:
the trusted authority center providing security parameters, invoking a parameter generation algorithm to generate the hash function and bilinear mapping parameters required by the system, and randomly selecting a number to compute a system master key;
the trusted authority center equally dividing an urban airspace into a plurality of unit blocks, assigning a unique identifier to each unit block, and then equally distributing the unit blocks to respective sentry stations for management;
the trusted authority center selecting a sufficiently large array to create a Bloom filter and initializing it to zero to prepare for subsequent route verification;
during construction and registration of the sentry stations, the trusted authority center generating an airspace scope and a private key therefor and delivering them offline to the sentry stations to enable the sentry stations to perform subsequent route verification operations.

4. The privacy-preserving and efficient low-altitude route authentication method of claim 3, wherein the route verification information generation phase specifically comprises the following steps:
the trusted authority center delineating legal routes for UAVs under the airspace of each sentry station and generating a set representing the legal routes;
the trusted authority center randomly selecting a number, computing and generating a set representing a no-fly zone, the set describing a no-fly zone for UAVs under the airspace of the sentry station;
Based on the legal route set and the no-fly zone set, the trusted authority center performing a Bloom filter construction operation to generate a hash function and a bit array;
the trusted authority center checking unit blocks in the legal route set, identifying false-positive blocks that may be misjudged by the Bloom filter as being in the no-fly zone, and recording the false-positive blocks in a set;
the trusted authority center generating a polynomial based on the false-positive block set and randomly selecting an element to generate an element sequence;
the trusted authority center using the master key to generate a signature for route information to ensure non-tamperability of the route information;
the trusted authority center distributing the generated route information and signature to UAVs for use in the subsequent route verification phase.

5. The privacy-preserving and efficient low-altitude route authentication method of claim 4, wherein the route information comprises a legal route set, a false-positive block set, a Bloom filter, and an element sequence.

6. The privacy-preserving and efficient low-altitude route authentication method of claim 4, wherein the route verification phase specifically comprises the following steps:
when a UAV first enters the airspace of a sentry station, the UAV transmitting information including a Bloom filter, an element sequence, verification parameters, and a signature to the sentry station; the sentry station first verifying the legitimacy of the signature to confirm that the task verification information provided by the UAV is legal;
when the sentry station detects that the UAV enters a new unit block, the sentry station computing a specific value and using the Bloom filter to verify whether the unit block belongs to the legal route of the UAV; if the verification passes, the sentry station continuing to monitor the flight trajectory of the UAV;
if the unit block does not belong to the legal route, the sentry station computing and transmitting a specific message to the UAV to request further verification;
upon receiving the message from the sentry station, the UAV selecting a specific element from the element sequence and computing a verification value, and then transmitting the verification value back to the sentry station;
upon receiving the verification value transmitted by the UAV, the sentry station performing a final verification; if the verification is successful, indicating that the unit block has passed false-positive verification and belongs to a part of the legal route of the UAV; the sentry station continuing to monitor the flight trajectory of the UAV until the UAV enters the next unit block.

7. A computer-readable storage medium storing a computer program, wherein the computer program, when executed by a processor, implements the privacy-preserving and efficient low-altitude route authentication method of claim 1.

8. A computer program product comprising a computer program, wherein the computer program, when executed by a processor, implements the privacy-preserving and efficient low-altitude route authentication method of claim 1.
